(19) United States
(12) Patent Application Publication
(10) Pub. No.: US 2012/0200516 A1
(43) Pub. Date: Aug. 9, 2012

(54) TOUCH PANEL AND METHOD FOR MANUFACTURING THE SAME

(75) Inventors: Jae Il Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 13/367,920

(22) Filed: Feb. 7, 2012

(30) Foreign Application Priority Data
Feb. 9, 2011 (KR) 1020110011541

(51) Int. Cl. G06F 3/041; H01H 11/00

(52) U.S. Cl. 345/173; 29/622

(57) ABSTRACT

Disclosed herein are a touch panel and a method for manufacturing the same. A touch panel 100 according to preferred embodiments of the present invention includes a transparent substrate 110; a self-recovering layer 120 formed on one surface of the transparent substrate 110; and a transparent electrode 130 patterned so as to form an opening 135 in the self-recovering layer 120, wherein the self-recovering layer 120 has colors corresponding to the transparent electrode 130 and fills the opening 135 by protruding a portion corresponding to the opening 135, such that the user may not recognize the transparent electrode 130, thereby improving visibility of the touch panel 100.

### CROSS REFERENCE TO RELATED APPLICATION

This application claims the benefit of Korean Patent Application No. 10-2011-0011541, filed on Feb. 9, 2011, entitled “Touch Panel and Method for Manufacturing The Same,” which is hereby incorporated by reference in its entirety into this application.

### BACKGROUND OF THE INVENTION

1. Technical Field

The present invention relates to a touch panel and a method for manufacturing the same.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has been widening the use of computers more and more, it is difficult to efficiently operate products using only a keyboard and mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the image display device.

Meanwhile, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, difficulty of designing and processing technologies, optical characteristics, electrical characteristics, mechanical characteristics, resistance to an environment, input characteristics, durability, and economic efficiency. Currently, a capacitive type touch panel and a digital resistive type touch panel in which multi-touch may be performed have been prominent.

However, the transparent electrode of the capacitive type touch panel and the digital resistive type touch panel according to the prior art needs to be patterned, wherein the transparent electrode has a unique color and thus, the shape of the patterned transparent electrode is recognized by the user. For example, when the transparent electrode is patterned in a bar shape, the user recognizes the bar shape and when the transparent electrode is patterned in a diamond shape, the user recognizes the diamond shape. Therefore, the touch panel according to the prior art has a bad effect on the image from the image display device and degrades the general visibility, due to the transparent electrode.

### SUMMARY OF THE INVENTION

The present invention has been made in an effort to provide a touch panel and a method for manufacturing the same capable of preventing a user from recognizing transparent electrodes by filing an opening between transparent electrodes with a self-recovering layer by adopting the self-recovering layer having colors corresponding to the transparent electrodes.

According to a preferred embodiment of the present invention, there is provided a touch panel, including: a transparent substrate; a self-recovering layer formed on one surface of the transparent substrate; and a transparent electrode patterned so as to form an opening on the self-recovering layer.

The self-recovering layer may have colors corresponding to the transparent electrode and fills the opening by protruding a portion corresponding to the opening.

The self-recovering layer may include: a substrate made of epoxy resin; an adhesive material provided in a microcapsule shape or a microchannel shape within the substrate; and a catalyst provided on the substrate to harden flowing out adhesive material.

The adhesive material may be dicyclopentadiene (DCPD).

The catalyst may be a Grubbs' catalyst.

The transparent electrode may include a conductive polymer.

The conductive polymer may include poly-3,4-ethylene dioxy thiophene/polystyrene sulfonate (PEDOT/PSS), polyaniline, polyacetylene, and polyphenylene vinylene.

According to another preferred embodiment of the present invention, there is provided a method for manufacturing a touch panel, including: (A) forming a self-recovering layer on one surface of a transparent substrate; (B) forming a transparent electrode on the self-recovering layer; and (C) patterning the transparent electrode so as to form an opening.

The patterning may include filling the opening by protruding a portion corresponding to the opening in the self-recovering layer by stimulating the self-recovering layer while patterning the transparent electrode, wherein the self-recovering layer has colors corresponding to the transparent electrode.

The self-recovering layer may include: a substrate made of epoxy resin; an adhesive material provided in a microcapsule shape or a microchannel shape within the substrate; and a catalyst provided on the substrate to harden flowing out adhesive material.

The adhesive material may be dicyclopentadiene (DCPD).

The catalyst may be a Grubbs' catalyst.

In the forming of the transparent electrode, the transparent electrode may include a conductive polymer.

The conductive polymer may include poly-3,4-ethylene dioxy thiophene/polystyrene sulfonate (PEDOT/PSS), polyaniline, polyacetylene, and polyphenylene vinylene.

### BRIEF DESCRIPTION OF THE DRAWINGS

FIG. 1 is a cross-sectional view of a touch panel according to a preferred embodiment of the present invention;

FIG. 2 is a perspective view cut after a first adhesive layer, a window, and a functional layer in the touch panel shown in FIG. 1.

FIGS. 3 and 4 are conceptual diagrams of a self-recovering layer shown in FIG. 1.

FIGS. 5 to 10 are cross-sectional views showing a process sequence of a method for manufacturing a touch panel according to a preferred embodiment of the present invention.

FIGS. 11 to 13 are cross-sectional views of touch panels manufactured using the preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first,” “second,” and so on are used to distinguish one element from another element, and the elements are not defined by the above terms. Further, in describing the present invention, a detailed description of related known functions or configurations will be omitted so as not to obscure the subject of the present invention.

Hereinafter, preferred embodiments of the present invention will be described in detail with reference to the accompanying drawings.

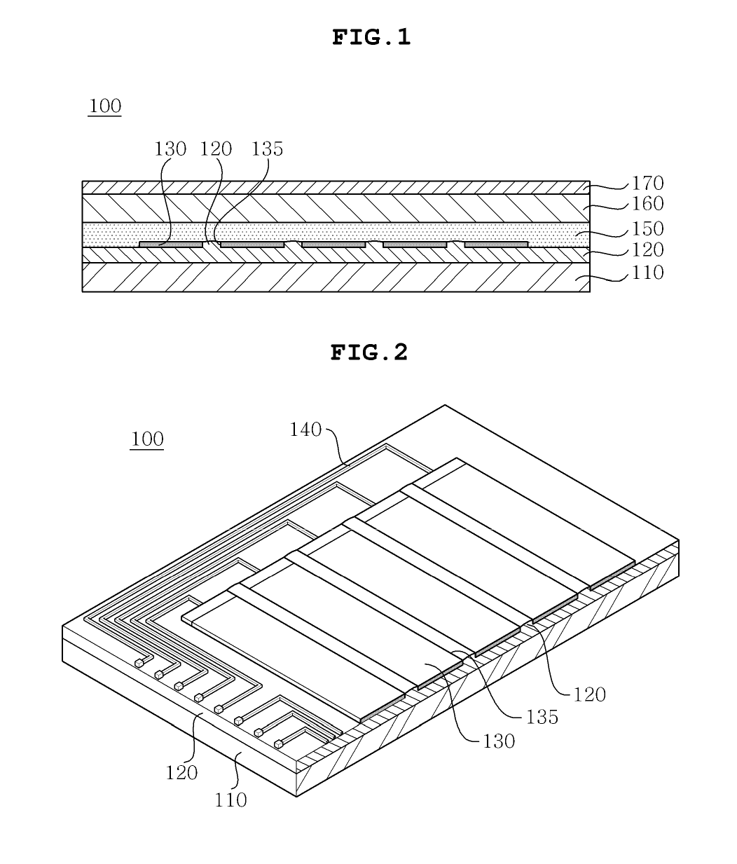

FIG. 1 is a cross-sectional view of a touch panel according to a preferred embodiment of the present invention and FIG. 2 is a perspective view cut after a first adhesive layer, a window, and a functional layer in the touch panel shown in FIG. 1.

As shown in FIGS. 1 and 2, the touch panel 100 according to the preferred embodiment of the present invention is configured to include a transparent substrate 110, a self-recovering layer 120 formed on one surface of the transparent substrate 110, and a transparent electrode 130 patterned so as to form an opening 135 on the self-recovering layer 120, wherein the self-recovering layer 120 has colors corresponding to the transparent electrode 130 and filling the opening 135 by protruding a portion corresponding to the opening 135.

The transparent substrate 110 serves to provide a region in which the self-recovering layer 120 and the transparent electrode 130 are sequentially formed. Here, the transparent substrate 110 needs to have support force capable of supporting the self-recovering layer 120 and the transparent electrode 130 and transparency capable of allowing a user to recognize an image provided from an image display device. In consideration of the support force and the transparency described above, the transparent substrate 110 may be made of polyethylene terephthalate (PET), polycarbonate (PC), poly methyl methacrylate (PMMA), polyethylene naphthalate (PEN), polyethersulpon (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but is not necessarily limited thereto. Meanwhile, in order to activate one surface of the transparent substrate 110, high frequency processing or primer processing may be performed. An adhesion between the transparent substrate 110 and the self-recovering layer 120 may be improved by activating one surface of the transparent substrate 110.

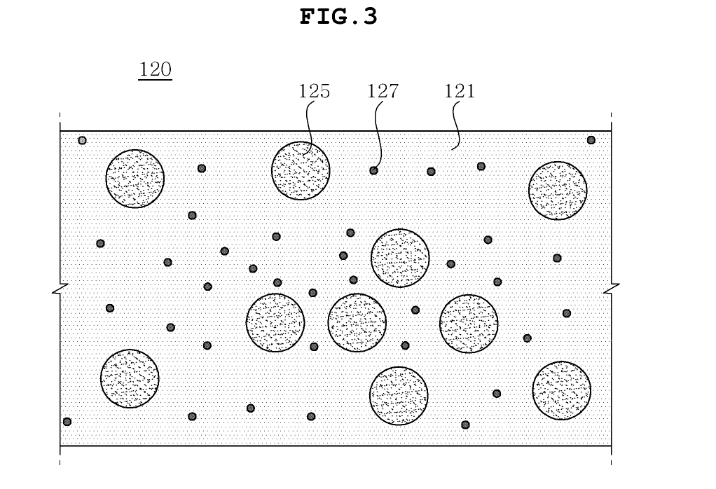

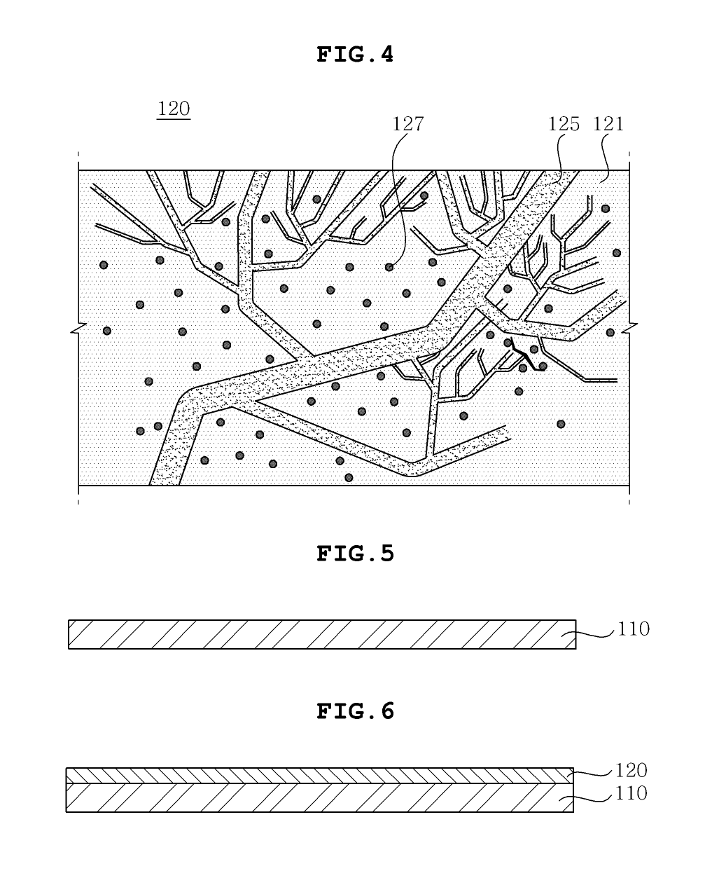

The self-recovering layer 120 serves to improve the visibility of the touch panel 100 by filling the opening 135 between the patterned transparent electrodes 130 and is formed on one surface of the transparent substrate 110. Herein, the self-recovering layer 120 is stimulated at the time of patterning the transparent electrode 130 and the stimulated portion is protruded while being stimulated to fill the opening 135. FIGS. 3 and 4 are conceptual diagrams of the self-recovering layer shown in FIG. 1. The self-recovering layer 120 will be described in detail with reference to FIGS. 3 and 4. The self-recovering layer 120 may be configured to include a substrate 121 made of epoxy resin, an adhesive material 125 provided in a microcapsule (see FIG. 3) shape or a microchannel (see FIG. 4) shape within the substrate 121, and a catalyst 127 provided on the substrate 121 to harden the flowing out adhesive material 125. Therefore, if the self-recovering layer 120 is stimulated when the transparent electrode 130 is patterned, the microcapsule (see FIG. 3) is broken at the stimulated portion and thus, the adhesive material 125 flows out therefrom and the adhesive material 125 flows out from the microchannel (see FIG. 4). The adhesive material 125 flowing out therefrom reacts with the catalyst 127 and thus, protruded while be hardened, such that the opening 135 of the transparent electrode 130 is filled. Meanwhile, as the adhesive material 125, dicyclopentadiene (DCPD) may be used, as the catalyst 127, and Grubbs' catalyst (for example, benzylidene-bis(tricyclohexylphosphine) dichlororuthenium) may be used. In this case, when the transparent electrode 130 is patterned, the self-recovering layer 120 is stimulated, the DCPD flows out and meets the Grubbs' catalyst. The DCPD and the Grubbs' catalyst are protruded while being hardened through ring opening metathesis polymerization (ROMP) reaction and fills the opening 135 of the transparent electrode 130.

Meanwhile, the self-recovering layer 120 has colors corresponding to the transparent electrode 130. For example, when the transparent electrode 130 is made of poly-3,4-ethylene dioxy thiophene/polystyrene sulfonate (PEDOT/PSS), in the transparent electrode 130, an L*value is 90 to 96, an a*value is −2.0 to 2.0, and a b*value is −2.0 to 4.0 based on an L*a*b color specification system. The L*a*b color specification system is color specification defined in 1976 in International Commission on Illumination (CIE). An L* value is brightness (luminosity) and an a*value and a b*value represents a color and a chroma. Therefore, similar to the self-recovering layer 120, the L*value may be 90 to 96, the a*value may be −2.0 to 2.0, and the b*value may be −2.0 to 4.0 based on the L*a*b color specification system. In order for the self-recovering layer 120 to have the colors corresponding to the transparent electrode 130, the self-recovering layer 120 may be added with colored ink including pigment or dye.

As described above, the self-recovering layer 120 fills the opening 135 between the transparent electrodes 130 and has colors corresponding to the transparent electrode 130 to improve the visibility of the touch panel 100 and the detailed description thereof will be described below.

The transparent electrode 130 serves to allow a controller to recognize touched coordinates when the input unit generates signals at the time of touch and are formed on one surface of the self-recovering layer 120. Herein, the transparent electrode 130 may be formed using usually used indium thin oxide (ITO) and conductive polymer having excellent flexibility and simplified coating process. The conductive polymer includes PEDOT/PSS, polyaniline, polyacetylene, polyphenylene vinylene, or the like. In addition, the transparent electrode 130 is patterned in a bar shape in the drawing, but is not limited thereto. Therefore, the transparent electrode 130 may be patterned in all the patterns known to the art such as a diamond shape, a circular shape, a squared shape, or the like.

Meanwhile, the transparent electrode 130 has a unique color and therefore, when the transparent electrode 130 is patterned to have the opening 135, the color difference between the transparent electrode 130 and the opening 135 occurs. In particular, when the transparent electrode 130 is made of the PEDOT/PSS, the transparent electrode 130 has blue and thus, the color difference between the transparent electrode 130 and the opening 135 seriously occurs, which makes it difficult to commercialize. However, as described above, in the touch panel 100 according to the preferred embodiment of the present invention, the self-recovering layer 120 having the colors corresponding to the transparent electrode 130 is protruded so as to fill the opening 135, such that the colors the transparent electrode 130 and the opening 135 are the same as each other. Consequently, even though the transparent electrode 130 made of the PEDOT/PSS has blue, the blue self-recovering layer 120 is filled in the opening 135 and thus, the user cannot recognize the color difference between the transparent electrode 130 and the opening 135. In addition, the preferred embodiments of the present invention can previously prevent the short between the transparent electrodes 130 adjacent to the opening 135 by forming the self-recovering layer 120 using the epoxy resin having the insulation.

In addition, an edge of the transparent electrode 130 is printed with the electrode wiring 140 that receives the electrical signal from the transparent electrode 130. In addition, as the materials for the electrode wirings 140, silver paste (Ag paste) having excellent electric conductivity or materials composed of organic silver may be used. However, the preferred embodiment of the present invention is not limited thereto and therefore, a conductive polymer, a metal oxide such as carbon black (including CNT) such as ITO, or a low-resistance metal such as metals, or the like, may be used.

Meanwhile, as shown in FIG. 1, the outside of the transparent electrode 130 is provided with the window 160 bonded by a first adhesive layer 150 to protect the transparent electrode 130. In addition, the outside of the window 160 may be provided with a functional layer 170 made of one of a hard coating layer, an anti-finger (AF) layer, an anti-glare (AG) layer, and an anti-reflection (AR) layer or a combination of two or more thereof.

FIGS. 5 to 10 are cross-sectional views showing a process sequence of a method for manufacturing a touch panel according to a preferred embodiment of the present invention.

As shown in FIGS. 5 to 10, the method for manufacturing a touch panel according to the preferred embodiment of the present invention is configured to include (A) forming the self-recovering layer 120 having colors corresponding to the transparent electrode 130 on one surface of the transparent substrate 110, (B) forming the transparent electrode 130 on the self-recovering layer 120, and (C) filling the opening 135 by protruding the portion corresponding to the opening 135 in the self-recovering layer 120 by stimulating the self-recovering layer 120 while patterning the transparent electrode 130 so as to form the opening 135.

First, as shown FIG. 5, the transparent substrate 110 is prepared. In this case, the transparent substrate 110 is to provide the region in which the self-recovering layer 120 and the transparent electrode 130 are sequentially formed at the process to be described below. Therefore, in order to improve the adhesion with the self-recovering layer 120, one surface of the transparent substrate 110 may be activated through the high frequency processing or the primer processing.

Next, as shown in FIG. 6, a process of forming the self-recovering layer 120 of the transparent substrate 110 is performed. Herein, as shown in FIGS. 3 and 4, the self-recovering layer 120 may be configured to include the substrate 121 made of epoxy resin, the adhesive material 125 such as the DCPD, or the like, provided in a microcapsule (see FIG. 3) shape or a microchannel (see FIG. 4) shape within the substrate 121, and the catalyst 127 such as the Grubbs' catalyst provided on the substrate 121 to harden the flowing out adhesive material 125. Further, the self-recovering layer 120 has the colors corresponding to the transparent electrode 130. To this end, the self-recovering layer 120 may be added with the colored ink including pigment or dye.

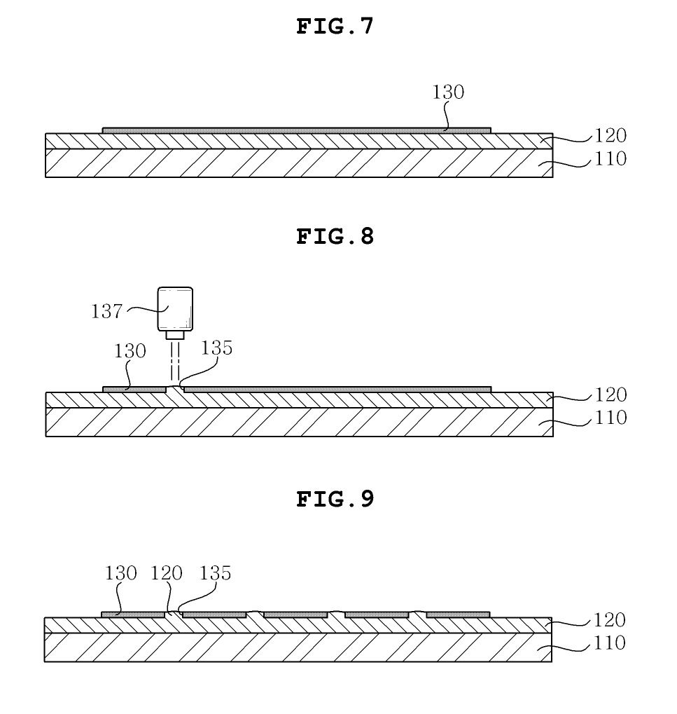

Next, as shown in FIG. 7, a process of forming the transparent electrode 130 on the self-recovering layer 120 is performed. Herein, the transparent electrode 130 may be formed using the conductive polymer including polyaniline, polyacetylene, or polyphenylene vinylene or ITO, or the like. In this case, the process of forming the transparent electrode 130 is not particularly limited, but the transparent electrode 130 may be formed on the front surface of the self-covering layer 120 using a drying process such as sputtering, evaporation, or the like, or a wetting process such as dip coating, spin coating, roll coating, spray coating, or the like.

Next, as shown in FIGS. 8 and 9, the transparent electrode 130 stimulates the self-recovering layer 120 while being patterned so as to form the opening 135 to protrude the portion corresponding to the opening 135 in the self-recovering layer 120 so as to fill the opening 135 In the case of the touch panel according to the prior art, when the transparent electrode 130 is patterned so as to form the opening 135, the color difference between the transparent electrode 130 and the opening 135 occurs. However, in the touch panel 100 according to the preferred embodiment, when the transparent electrode 130 is patterned so as to form the opening 135 using a laser 137, or the like, the self-recovering layer 120 provided in the inner side of the transparent electrode 130 is protruded so as to fill the opening 135, thereby removing the color difference between the transparent electrode 130 and the opening 135. In detail, when the laser 137 forms the opening 135 and then, the self-recovering layer 120 is stimulated, the adhesive material 125 of the self-recovering layer 120 flows out (see FIGS. 3 and 4) and the flowing out adhesive material 125 is protruded by reacting with the catalyst 127 so as to fill the opening 135. In this case, the transparent electrode 130 and the self-recovering layer 120 has the colors corresponding to each other and thus, the opening 135 filled with the transparent electrode 130 and the self-recovering layer 120 has the same color. Consequently, the user cannot recognize the color difference between the transparent electrode 130 and the opening 135, thereby improving the visibility of the touch panel. In addition, the opening 135 between the transparent electrodes 130 is filled by stimulating the self-recovering layer 120 while patterning the transparent electrode 130 and thus, only the opening 135 may be filled with the self-recovering layer 120 without performing the complicated manufacturing process. Meanwhile, when the self-recovering layer 120 is stimulated while patterning the transparent electrode 130, it is not necessarily to use the laser 137 and thus, all the physical patterning processes known to the art may be used.

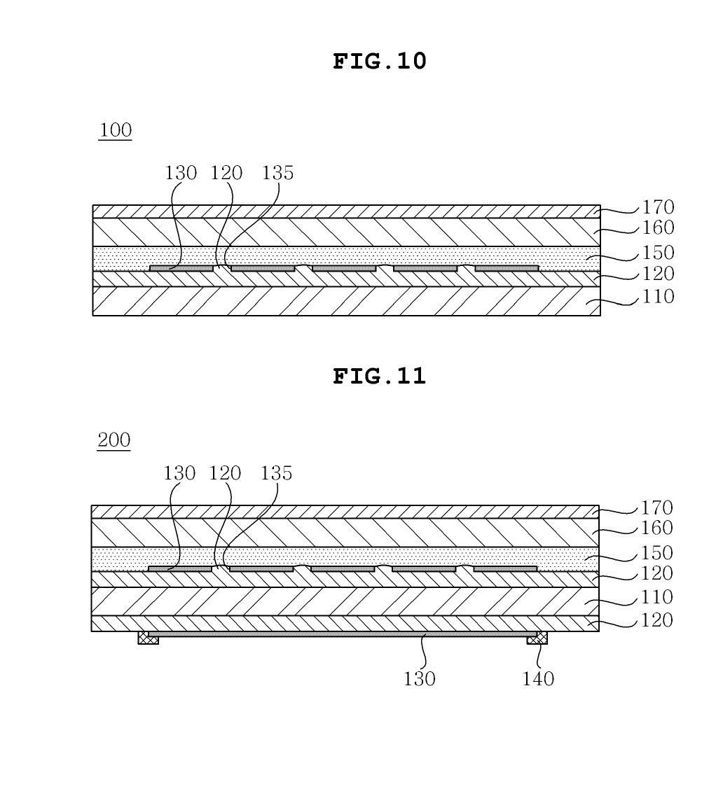

Next, as shown in FIG. 10, the outside of the transparent electrode 130 is provided with the window 160 bonded by the first adhesive layer 150 and the outside of the window 160 may be disposed with the functional layer 170 made of one of the anti-finger (AF) layer, the anti-glare (AG) layer, and the anti-reflection (AR) layer or a combination of two or more thereof

In the case of the touch panel 100 according to the preferred embodiment of the present invention, a self capacitive type touch panel or a mutual capacitive type touch panel may be manufactured using the transparent electrode 130 having 1-layer structure. However, the touch panel according to the preferred embodiment of the present invention is not limited thereto but may be manufactured in various types having the configurations, as described below.

FIGS. 11 to 13 are cross-sectional views of touch panels manufactured using the preferred embodiment of the present invention.

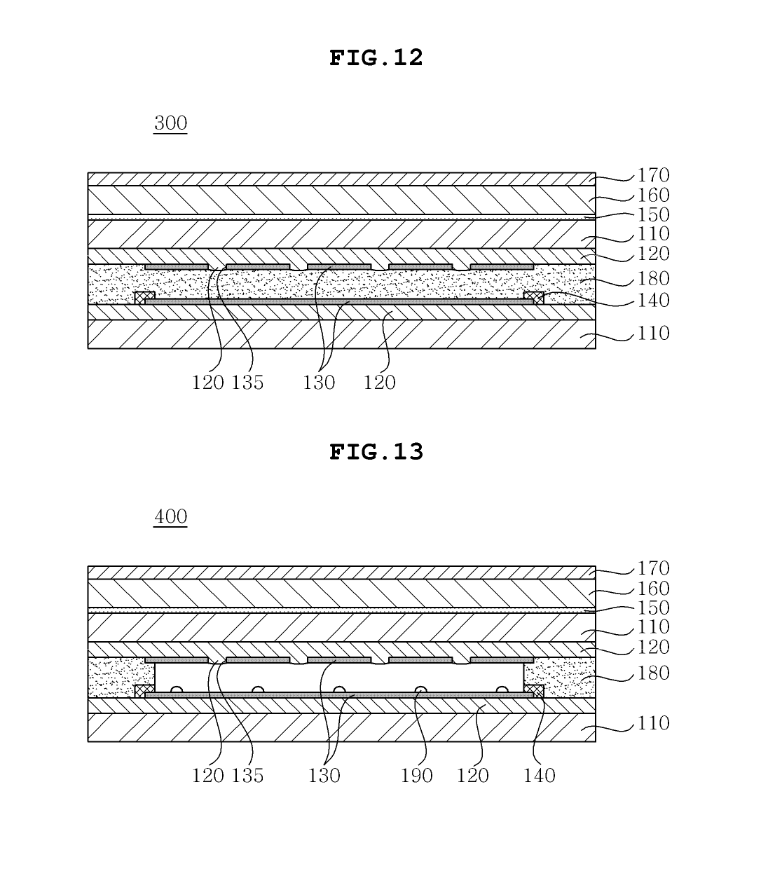

As shown in FIG. 11, the mutual capacitive type touch panel 200 (see FIG. 11) may be manufactured by forming the self-recovering layer 120 on both surfaces of the transparent substrate 110 and patterning the transparent electrode 130. In addition, as shown in FIGS. 12 and 13, a mutual capacitive type touch panel 300 (see FIG. 12) or a resistive type touch panel 400 (see FIG. 13) may be manufactured by preparing two transparent substrates 130 including the self-recovering layer 120 formed on one surface thereof and bonding the two transparent substrates 110 to each other using a second adhesive layer 180 so that the transparent electrodes 130 face each other. Herein, in the case of the mutual capacitive type touch panel 300 (see FIG. 12), the second adhesive layer 180 is bonded to the front surface of the self-recovering layer 120 so that the two facing transparent electrodes 130 are insulated from each other. On the other hand, in the case of the digital resistive type touch panel 400 (see FIG. 13), the second adhesive layer 190 is bonded only to the edge of the self-recovering layer 120 so that the two facing transparent electrodes 130 are in contact with each other when pressure of an input unit is operated and a dot spacer 190 providing repulsive force is provided on the exposed surfaces of the transparent electrode 130, so that the transparent electrode 130 is returned to its original position when the pressure of the input unit is removed. Meanwhile, the outermost portion of the touch panel 200, 300, and 400 may be disposed with the window 160 and the functional layer 170 that are bonded to each other by the first adhesive layer 150.

The touch panels 200, 300, and 400 manufactured by using the preferred embodiment of the present invention uses the self-recovering layer 120 having the colors corresponding to the transparent electrode 130 to fill the opening 135 with the self-recovery layer 120 while patterning the transparent electrode 130. Consequently, the user may not recognize the transparent electrode 130 and thus, the visibility of the touch panels 200, 300, and 400 is improved.

As set forth above, the preferred embodiment of the present invention can improve the visibility by preventing the user from recognizing the transparent electrodes by filling the opening between the transparent electrode with the self-recovering layer having color corresponding to the transparent electrodes.

Further, the preferred embodiment of the present invention can accurately fill the self-recovering layer in only the opening between the transparent electrodes without performing the complicated manufacturing process by filling the opening between the transparent electrodes by stimulating the self-recovering layer while patterning the transparent electrodes.

The preferred embodiments of the present invention can prevent the short between the transparent electrodes adjacent to the opening by forming the self-recovering layer using the epoxy resin having the insulation.

Although the preferred embodiments of the present invention have been disclosed for illustrative purposes, they are for specifically explaining the present invention and thus a touch panel and a method of manufacturing the same according to the present invention are not limited thereto, but those skilled in the art will appreciate that various modifications, additions and substitutions are possible, without departing from the scope and spirit of the invention as disclosed in the accompanying claims. Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate;
a self-recovering layer formed on one surface of the transparent substrate; and
a transparent electrode patterned so as to form an opening on the self-recovering layer.

2. The touch panel as set forth in claim 1, wherein the self-recovering layer has colors corresponding to the transparent electrode and fills the opening by protruding a portion corresponding to the opening.

3. The touch panel as set forth in claim 1, wherein the self-recovering layer includes:
a substrate made of epoxy resin;
an adhesive material provided in a microcapsule shape or a microchannel shape within the substrate; and
a catalyst provided on the substrate to harden flowing out adhesive material.

4. The touch panel as set forth in claim 3, wherein the adhesive material is dicyclopentadiene (DCPD).

5. The touch panel as set forth in claim 3, wherein the catalyst is a Grubbs' catalyst.

6. The touch panel as set forth in claim 1, wherein the transparent electrode includes a conductive polymer.

7. The touch panel as set forth in claim 6, wherein the conductive polymer includes poly-3,4-ethylene dioxy thiophene/polystyrene sulfonate (PEDOT/PSS), polyaniline, polyacetylene, and polyphenylene vinylene

8. A method for manufacturing a touch panel, comprising:
(A) forming a self-recovering layer on one surface of a transparent substrate;
(B) forming a transparent electrode on the self-recovering layer; and
(C) patterning the transparent electrode so as to form an opening.

9. The method as set forth in claim 8, wherein the patterning includes filling the opening by protruding a portion corresponding to the opening in the self-recovering layer by stimulating the self-recovering layer while patterning the transparent electrode, the self-recovering layer having colors corresponding to the transparent electrode.

10. The method as set forth in claim 8, wherein the self-recovering layer includes:
a substrate made of epoxy resin;
an adhesive material provided in a microcapsule shape or a microchannel shape within the substrate; and
a catalyst provided on the substrate to harden flowing out adhesive material.

11. The method as set forth in claim 10, wherein the adhesive material is dicyclopentadiene (DCPD).

12. The method as set forth in claim 10, wherein the catalyst is a Grubbs' catalyst.

13. The method as set forth in claim 8, wherein in the forming of the transparent electrode, the transparent electrode includes a conductive polymer.

14. The method as set forth in claim 13, wherein the conductive polymer includes poly-3,4-ethylene dioxy thiophene/polystyrene sulfonate (PEDOT/PSS), polyaniline, polyacetylene, polyphenylene vinylene
